(19) United States
(12) Patent Application Publication
(10) Pub. No.: US 2025/0379481 A1
(43) Pub. Date: Dec. 11, 2025

(54) MOTOR STRUCTURE AND STATOR ASSEMBLY THEREOF

(71) Applicant: SHIH JIEH NENG CO.,LTD, Taichung City (TW)

(72) Inventor: SHIH-PING HO, Taichung City (TW)

(21) Appl. No.: 19/218,594

(22) Filed: May 26, 2025

(30) Foreign Application Priority Data
Jun. 5, 2024 (TW) 113205841

(51) Int. Cl. H02K 3/26

(52) U.S. Cl. CPC H02K 3/26; H02K 2203/03

(57) ABSTRACT

A motor structure and a stator assembly thereof. The motor structure includes a housing, a stator assembly disposed in the housing, and a rotor assembly disposed in the housing. The stator assembly includes a stator core and at least one coil circuit board connected to the stator core. The stator core has a magnetic core body and a plurality of magnetic conductive columns that are disposed on the magnetic core body. A through hole is formed in a center of the magnetic core body, and the magnetic conductive columns are arranged around the through hole and are erected on the magnetic core body. The coil circuit board has a plurality of printed circuits corresponding to a quantity of the magnetic conductive columns, and the printed circuits are respectively wound around the magnetic conductive columns. The rotor assembly is configured to rotate through the stator assembly.

### CROSS-REFERENCE TO RELATED PATENT APPLICATION

This application claims the benefit of priority to Taiwan Patent Application No. 113205841, filed on Jun. 5, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a motor structure and a stator assembly thereof, and more particularly to a motor structure and a stator using a coil circuit board to replace a conventional coil.

### BACKGROUND OF THE DISCLOSURE

In a conventional motor structure, a stator assembly is a plurality of coils wrapped around the silicon steel sheet to form multiple sets of windings on the silicon steel sheet. However, the conventional motor structure with a stator assembly made of silicon steel sheet has issues of slow rotational speed (i.e., low switching speed), high loss, and a large size.

### SUMMARY OF THE DISCLOSURE

In response to the above-referenced technical inadequacy, the present disclosure provides a motor structure and stator assembly thereof that can effectively improve on the issues in a conventional motor structure.

In order to solve the above-mentioned problem, one of the technical aspects adopted by the present disclosure is to provide a motor structure. The motor structure includes a housing, a stator assembly, and a rotor assembly. The stator assembly is disposed in the housing. The stator assembly includes a stator core, and at least one coil circuit board. The stator core has a magnetic core body and a plurality of magnetic conductive columns that are disposed on the magnetic core body. A through hole is formed in a center of the magnetic core body, and the magnetic conductive columns are arranged around the through hole and are erected on the magnetic core body. The at least one coil circuit board has a plurality of printed circuits corresponding to a quantity of the magnetic conductive columns, and the printed circuits are respectively wound around the magnetic conductive columns. The rotor assembly is disposed in the housing. The rotor assembly is configured to rotate through the stator assembly.

In order to solve the above-mentioned problems, another one of the technical aspects adopted by the present disclosure is to provide a stator assembly of a motor structure. The stator assembly includes a stator core, and at least one coil circuit board. The stator core has a magnetic core body and a plurality of magnetic conductive columns that are disposed on the magnetic core body. A through hole is formed in a center of the magnetic core body, and the magnetic conductive columns are arranged around the through hole and are erected on the magnetic core body. The at least one coil circuit board has a plurality of printed circuits corresponding to a quantity of the magnetic conductive columns, and the printed circuits are respectively wound around the magnetic conductive columns.

Therefore, in the motor structure and stator assembly thereof provided by the present disclosure, by virtue of “the printed circuits on the at least one coil circuit board being respectively wound around the magnetic conductive columns,” and “a material of the stator core being ferrite core or other magnetic material,” a switching speed of a motor control circuit is increased to achieve goals of low inductance, high power density and small size.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an internal structure of a motor structure according to a first embodiment of the present disclosure;

FIG. 2 is a schematic perspective view of a stator assembly and a rotor assembly of FIG. 1;

FIG. 3 is a schematic perspective view of the stator assembly of FIG. 2;

FIG. 4 is a schematic side view of FIG. 3;

FIG. 5 to FIG. 7 are schematic partial exploded views of portion V of FIG. 1;

FIG. 8 is a schematic top view of the stator assembly according to a second embodiment of the present disclosure; and

FIG. 9 is a schematic top view of the stator assembly according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

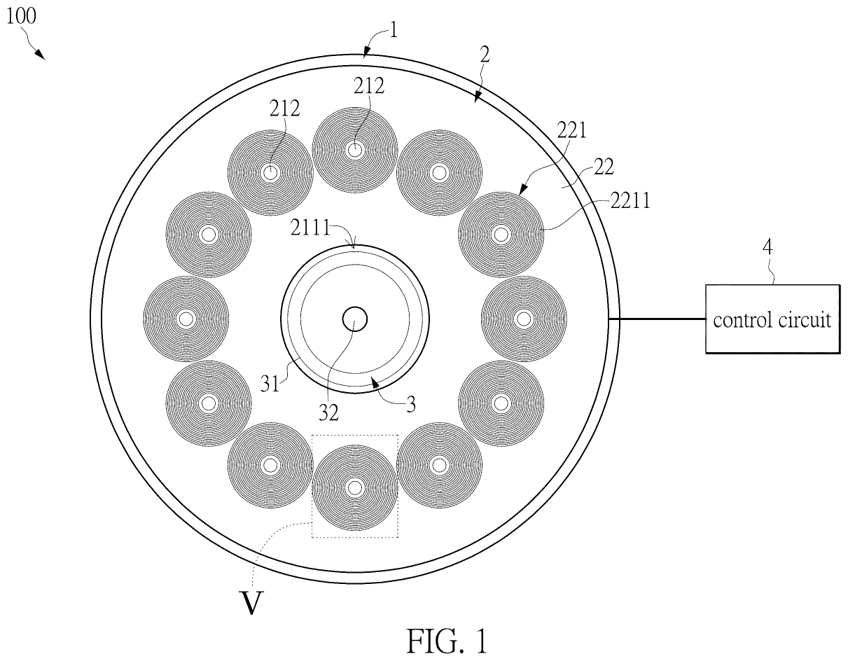

Referring to FIG. 1 to FIG. 7, a first embodiment of the present disclosure provides a motor structure 100. It should be noted that, the present embodiment corresponds to relevant quantities and shapes mentioned in the accompanying drawings and is only intended to specifically illustrate the implementation of this creation to facilitate an understanding of its content. It is not meant to limit the scope of protection of the present disclosure.

The present disclosure provides the motor structure 100 to eliminate a use of silicon steel sheets for magnetic conduction, thereby reducing volume of the motor structure 100. In addition, the motor structure 100 of the present embodiment is configured to accommodate a high switching speed of a control circuit, achieving low inductance, high power density, and a compact size.

It should be noted first that, in order to facilitate understanding of the present embodiment, the drawings of the present embodiment only show a partial structure of the motor structure 100 so as to clearly show structure and connection relationship of each of the components of the motor structure 100, but the present disclosure is not limited to what is shown in the drawings. The structure and the connection relationship of each of the components of the motor structure 100 in the present embodiment will be introduced below.

As shown in FIG. 1, the motor structure 100 of the present embodiment includes a housing 1, a stator assembly 2 that is accommodated in the housing 1, a rotor assembly 3 that is spaced apart from the stator assembly 2, and a control circuit 4 that is electrically coupled to the stator assembly 2 and the rotor assembly 3.

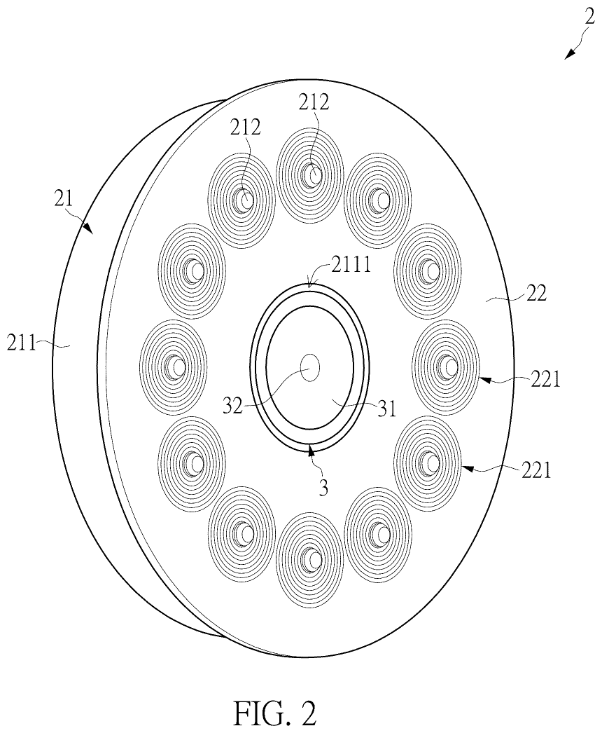

As shown in FIG. 1 and FIG. 2, in the present embodiment, the housing 1 is a hollow cylinder. That is to say, an accommodating space is disposed in the housing 1 (not shown in the drawings) for accommodating the stator assembly 2 and the rotor assembly 3, but the present disclosure is not limited thereto. For example, in other embodiments of the present disclosure not shown in the drawings, a shape of the housing 1 can also be square, but the accommodating space of the housing 1 is cylindrical so as to accommodate the stator assembly 2 and the rotor assembly 3 therein.

In the present disclosure, the housing 1 has an upper housing (not shown in the drawings) and a lower housing (not shown in the drawings). The housing 1 is configured to utilize the upper housing and the lower housing so that the stator assembly 2, the rotor assembly 3, and the control circuit 4 are configured to be accommodated in the housing 1, but the present disclosure is not limited thereto.

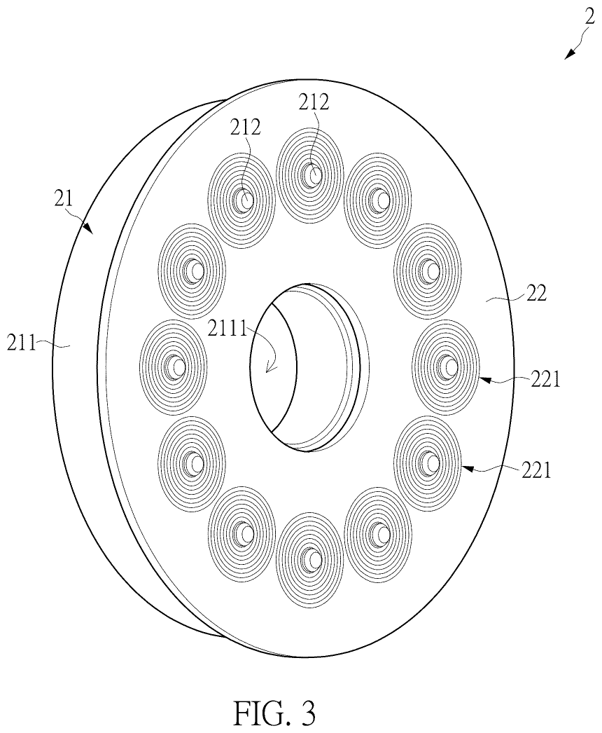

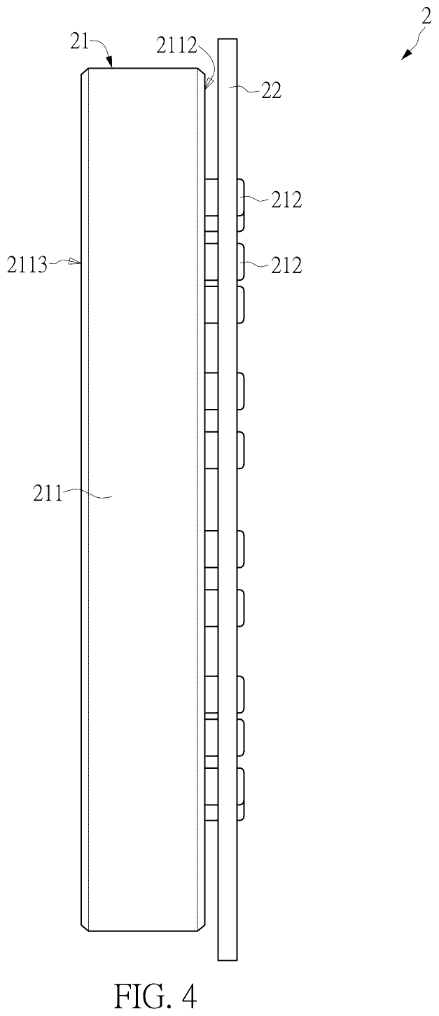

As shown in FIG. 3 and FIG. 4, in the present disclosure, a shape of the stator assembly 2 is roughly cylindrical, and a cross-sectional shape of the stator assembly 2 is roughly circular. Accordingly, the stator assembly 2 is configured to be assembled in the housing 1, but the present disclosure is not limited thereto. The stator assembly 2 includes a stator core 21 and at least one coil circuit board 22 that is disposed on the stator core 21.

In the present embodiment, a material of the stator core 21 is ferrite core or other magnetic material. Since ferrite core has advantages over silicon steel sheets, such as high magnetic permeability, easy availability, and low cost, using the ferrite core as the material for the stator core 21 can reduce the inductance of the motor structure 100, decrease the number of winding turns required, minimize the overall size of the motor structure 100, and lower costs.

As shown in FIG. 3 and FIG. 4, a shape of the stator core 21 is slightly cylindrical and is configured to be effectively accommodated in the housing 1. The stator core 21 has a magnetic core body 211 and a plurality of magnetic conductive columns 212 that are disposed on the magnetic core body 211. A shape of the magnetic core body 211 is roughly cylindrical. A through hole 2111 is formed in a center of the magnetic core body 211, a shape of the through hole 2111 is circular, and the through hole 2111 and the magnetic core body 211 are designed to be concentric circles. The magnetic core body 211 has a first side surface 2112 and a second side surface 2113 that are located on opposite sides.

A shape of the first side surface 2112 is roughly circular, but the present disclosure is not limited thereto. The first side surface 2112 is adjacent to the at least one coil circuit board 22, and a plurality of magnetic conductive columns 212 are disposed on the first side surface 2112 of the magnetic core body 212. The magnetic conductive columns 212 are arranged around the through hole 2111 and are erected on the magnetic core body 211.

It should be noted that, a quantity of the magnetic conductive columns 212 is an even number in the present embodiment. That is to say, the quantity of the magnetic conductive columns 212 of the present embodiment is 12, the magnetic conductive columns 212 are located on opposite sides of the through hole 2111 to form windings of different polarities so that the rotor assembly 3 rotates, but the present disclosure is not limited thereto. For example, in other embodiments of the present disclosure not shown in the drawings, the quantity of the magnetic conductive columns 212 can be adjusted to an odd number or an even number according to a winding method of the coil circuit board 22.

In the present embodiment, the magnetic conductive columns 212 are evenly distributed around the through hole 2111. That is to say, the magnetic conductive columns 212 are arranged in a circular shape around the through hole 2111, and a plurality of distances between adjacent magnetic conductive columns 212 in the magnetic conductive columns 212 are the same, but the present disclosure is not limited thereto. For example, in other embodiments of the present disclosure not shown in the drawings, the distances between the adjacent magnetic conductive columns 212 in the magnetic conductive columns 212 can be adjusted according to actual design requirements.

Furthermore, in the present disclosure, the magnetic conductive columns 212 and the magnetic core body 211 can be integrally formed as a single one-piece structure, and a material of the magnetic conductive columns 212 is the same as the ferrite core of the magnetic core body 211, but the present disclosure is not limited thereto. For example, in other embodiments of the present disclosure not shown in the drawings, the material of the magnetic conductive columns 212 is different from the material of the magnetic core body 211, and the magnetic conductive columns 212 are connected to the magnetic core body 211 by a fixed connection method (e.g., welding, fusion, or screw connection) or are adjusted and changed according to actual design requirements.

As shown in FIG. 3 and FIG. 4, the at least one coil circuit board 22 has a plurality of printed circuits 221 corresponding to the quantity of the magnetic conductive columns 212, and the printed circuits 211 are respectively wound around the magnetic conductive columns 212. In the present disclosure, a quantity of the at least one coil circuit board 22 is one, but the present disclosure is not limited thereto. The coil circuit board 22 is a multi-layer circuit board, a plurality of fixing through holes 222 corresponding to the quantity of the magnetic conductive columns 212 are formed in the coil circuit board 22, and the fixing through holes 222 are respectively provided for the magnetic conductive columns 212 to pass through.

It should be noted that, the fixing through holes 222 correspond to positions of the magnetic conductive columns 212 are arranged in a circular shape around the through hole 2111, and a plurality of distances between adjacent fixing through holes 222 in the fixing through holes 222 are the same, but the present disclosure is not limited thereto. For example, in other embodiments of the present disclosure not shown in the drawings, the distances between adjacent fixing through holes 222 in the fixing through holes 222 can be adjusted and changed according to actual design requirements.

In addition, the printed circuits 221 on the coil circuit board 22 are respectively wound around the fixing through holes 222. In the present disclosure, each of the printed circuits 221 is wound around each of the fixing through holes 222 on the coil circuit board 22, which is equivalent to being wound around each of the magnetic conductive columns 212. That is to say, each of the printed circuits 221 is wound around each of the magnetic conductive columns 212 to form a winding. The printed circuits 221 on the coil circuit board 22 are respectively wound around the magnetic conductive columns 212 to form a plurality of windings, and the rotor assembly 3 is configured to rotate through the windings.

It should be noted that, in the present disclosure, the printed circuits 221 on the coil circuit board 22 are configured to replace conventional coils and are respectively wound around the magnetic conductive columns 212 to form the windings different from conventional windings formed by silicon steel sheets, so that a volume of the stator assembly 2 of the present embodiment is much smaller than that of conventional stator assembly.

It should be noted that, in the present disclosure, in order to enable the windings and the rotor assembly 3 to generate magnetic force so as to enable the rotor assembly 3 to rotate, proper arrangement of the printed circuits 221 on the coil circuit board 22 of the present disclosure is important. The following is a description of the printed circuits 221 on the coil circuit board 22.

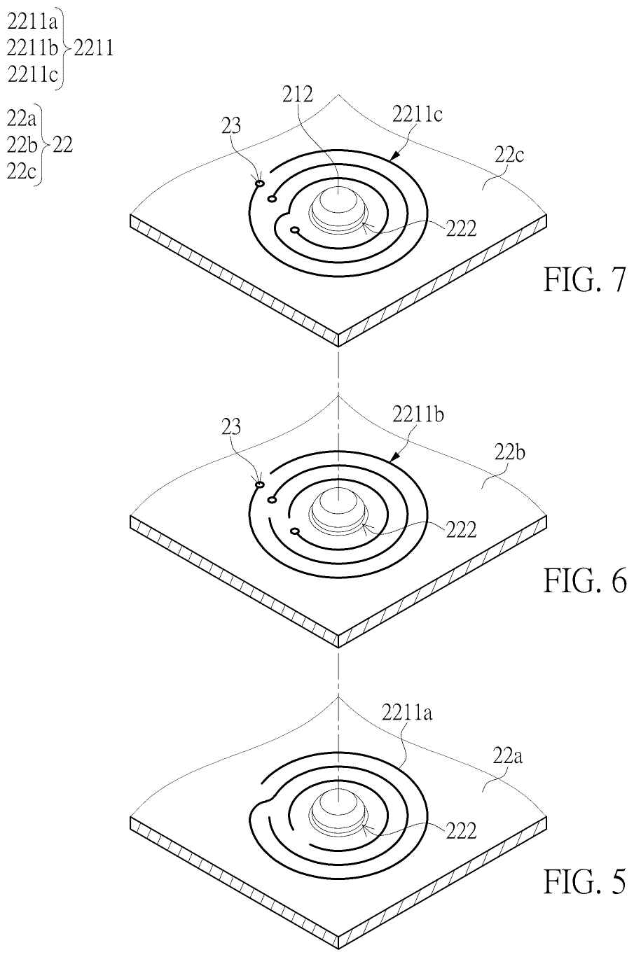

As shown in FIG. 5 to FIG. 7, it should be noted first that, in order to facilitate understanding of the present embodiment, each of the printed circuits 221 on the coil circuit board 22 is wound around each of the magnetic conductive columns 212, the present embodiment is described with reference to a single printed circuit 221 on the coil circuit board 22 in FIG. 3 (i.e., as shown in the single printed circuit 221 in portion V of FIG. 1).

The coil circuit board 22 of the present embodiment is the multi-layer circuit board, the multi-layer circuit board includes a plurality of circuit boards, and the printed circuits 221 are disposed on each layer of the circuit boards. For ease of illustration, the coil circuit board 22 of the present disclosure is described as a three-layer circuit board, but the present disclosure is not limited thereto. A number of layers of the coil circuit board 22 can be adjusted according to actual design requirements.

As shown in FIG. 5 to FIG. 7, the coil circuit board 22 of the present embodiment includes a first layer coil circuit board 22a, a second layer coil circuit board 22b, and a third layer coil circuit board 22c. Each of the printed circuits 221 includes a plurality of ring conductive patterns 2211 on each layer of the coil circuit board 22, the ring conductive patterns 2211 are spaced apart from each other. That is to say, the first layer coil circuit board 22a, the second layer coil circuit board 22b, and the third layer coil circuit board 22c respectively include a plurality of first ring conductive patterns 2211a, a plurality of second ring conductive patterns 2211b, and a plurality of third ring conductive patterns 2211c. The first ring conductive patterns 2211a, the second ring conductive patterns 2211b, and the third ring conductive patterns 2211c correspond to each other along a height direction.

Furthermore, a distance between any two adjacent first ring conductive patterns 2211a in the first ring conductive patterns 2211a is the same; a distance between any two adjacent second ring conductive patterns 2211b in the second ring conductive patterns 2211b is the same; and a distance between any two adjacent third ring conductive patterns 2211c in the third ring conductive patterns 2211c is the same, but the present disclosure is not limited thereto. For example, in other embodiments of the present disclosure not shown in the drawings, the distance between the adjacent ring conductive patterns 2211 in the ring conductive patterns 2211 gradually increases in a direction away from the fixing through hole 222 or can be adjusted according to actual design requirements.

In addition, a diameter of the ring conductive patterns 2211 of each layer of the coil circuit board 22 gradually increase in a direction away from the fixing through hole 222, and each of the ring conductive patterns 2211 of the adjacent coil circuit board 22 is electrically coupled to each other through a via hole 23. Specifically speaking, in the present embodiment, the winding method of the printed circuit 221 on the coil circuit board 22 is that the first ring conductive pattern 2211a is firstly wound around a first circle of the first ring conductive pattern 2211a that is closest to the magnetic conductive column 212 (as shown in FIG. 5), and then the first circle of the first ring conductive pattern 2211a is electrically connected to a first circle of the second ring conductive patterns 2211b of the second layer coil circuit board 22b that is closest to the magnetic conductive column 212 through the via hole 23 (as shown in FIG. 6), the first circle of the second ring conductive patterns 2211b is then electrically connected to a first circle of the third ring conductive patterns 2211c that is closest to the magnetic conductive column 212 of the third layer coil circuit board 22c through the via hole 23 (as shown in FIG. 7), so that the first circle of the printed circuit 221 wound around the magnetic conductive column 212 is completed.

Afterwards, the third ring conductive pattern 2211c is arranged around an outer periphery of the first circle of the third ring conductive pattern 2211c, a second circle and a third circle of the ring conductive pattern 2211c are sequentially wound in the above-mentioned winding method. As described above, the diameter of the ring conductive pattern 2211 of each layer of the coil circuit board 22 gradually increase in a direction away from the fixing through hole 222, and each of the ring conductive patterns 2211 of the adjacent coil circuit board 22 is electrically coupled to each other through the via hole 23.

As shown in FIG. 5 to FIG. 7, this is only one of the winding methods of the printed circuit 221 of the present embodiment, but the present disclosure is not limited thereto. For example, in other embodiments of the present disclosure not shown in the drawings, the printed circuit 221 is configured to be firstly provided with the ring conductive patterns 2211 disposed on each layer of the coil circuit boards 22, and the ring conductive patterns 2211 in any two adjacent coil circuit board 22 are electrically connected to each other through the via hole 23.

As shown in FIG. 1 and FIG. 2, the rotor assembly 3 is spaced apart from the magnetic core body 211, and the rotor assembly 3 is configured to rotate through the stator assembly 2. Specifically speaking, the rotor assembly 3 includes a rotor bearing 31 and a rotating shaft 32 that is disposed on the rotor bearing 31, the rotating shaft 32 is arranged on an axis of the rotor bearing 31.

In addition, as shown in FIG. 1, the control circuit 4 is operable to control the stator assembly 2 and the rotor assembly 3 so that the rotating shaft 32 of the rotor assembly 3 is rotated in the through hole 2111 of the stator assembly 2. Specifically speaking, the control circuit 4 is configured to be disposed on a control circuit board (not shown in the drawings), the control circuit 4 is electrically coupled to the stator assembly 2 and the rotor assembly 3 through the control circuit board to control the stator assembly 2 and the rotor assembly 3 (the control circuit 4 is electrically coupled to the stator assembly 2 and the rotor assembly 3 using technical means commonly employed by those skilled in the art, for ease of illustration, FIG. 1 shows that the control circuit 4 is connected to the stator assembly 2 to simply illustrate that the control circuit 4 electrically couples the stator assembly 2 and the rotor assembly 3.) so that the rotating shaft 32 of the rotor assembly 3 is rotated in the through hole 2111 of the stator assembly 2, but the present disclosure is not limited thereto.

For example, in other embodiments of the present disclosure not shown in the drawings, the control circuit is configured to be integrally formed on the coil circuit board 22, the control circuit 4 is electrically connected to the stator assembly 2 and the rotor assembly 3 through the coil circuit board 22 to control the stator assembly 2 and the rotor assembly 3, so that the rotating shaft 32 of the rotor assembly 3 is rotated in the through hole 2111 of the stator assembly 2.

### Second Embodiment

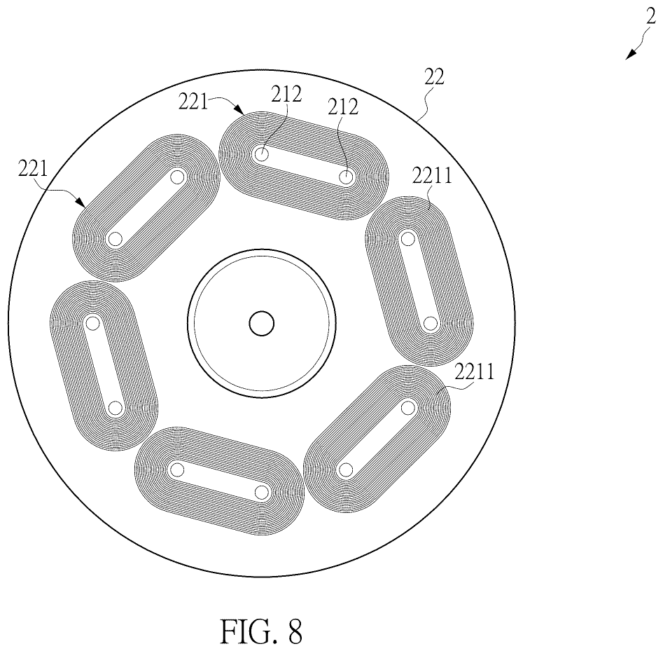

Referring to FIG. 8, a second embodiment of the present disclosure, which is similar to the above-mentioned first embodiment, is provided. For the sake of brevity, descriptions of the same components in the first and second embodiments of the present disclosure will be omitted herein, and the following description only discloses different features between the first and second embodiments.

As shown in FIG. 8, the winding method of the printed circuits 221 on the coil circuit board 22 is different from the embodiments of FIG. 1 to FIG. 7, the printed circuits 221 of the coil circuit board 22 of the present embodiment are wound around two magnetic conductive columns 212 as a group to form a winding. That is to say, in the present embodiment, the printed circuits 221 are wound around the periphery of the two magnetic conductive columns 212 to form the winding, but the present disclosure is not limited thereto. For example, in other embodiments of the present disclosure not shown in the drawings, in addition to the winding methods of the printed circuits 221 of the coil circuit board 22 shown in FIG. 5 and FIG. 6, the winding methods may also include overlapping winding, concentric winding, or wave winding. These are winding methods that a person having ordinary skill in the art can easily associate with the winding methods of FIG. 5 and FIG. 6, and the present disclosure omits description thereof for the sake of brevity.

### Third Embodiment

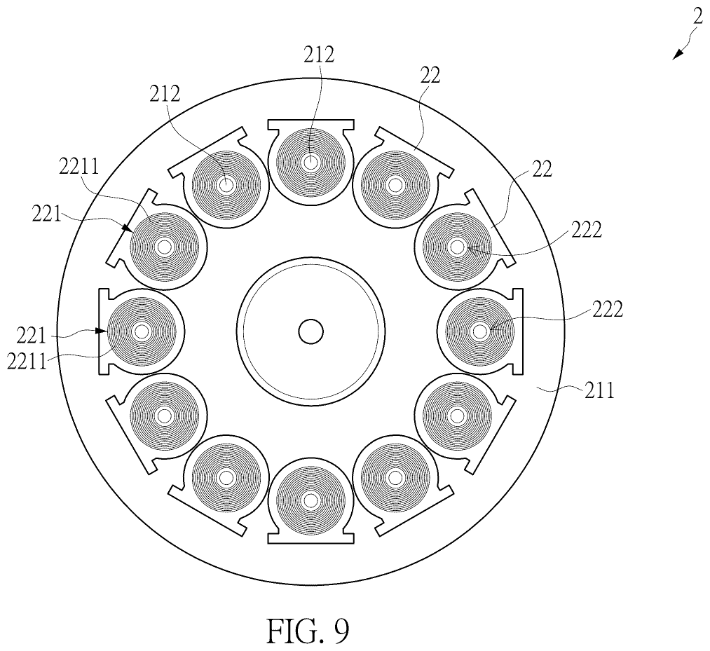

Referring to FIG. 9, a third embodiment of the present disclosure, which is similar to the above-mentioned embodiment, is provided. For the sake of brevity, descriptions of the same components in the third and above-mentioned embodiments of the present disclosure will be omitted herein, and the following description only discloses different features between the third and above-mentioned embodiments.

As shown in FIG. 9, a quantity of the at least one coil circuit board 22 corresponding to the quantity of the magnetic conductive columns 212 is multiple. In the present embodiment, the quantity of the at least one coil circuit board 22 corresponding to the quantity of the magnetic conductive columns 212 is 12. Each of the coil circuit boards 22 has a fixing through hole 222, and the fixing through hole 222 of the coil circuit boards 22 is respectively sleeved around the magnetic conductive columns 212, each of the coil circuit boards 22 has the printed circuit 221, and the printed circuit 221 of each of the coil circuit boards 22 is arranged around the fixing through hole 222.

Specifically speaking, in the present disclosure, the coil circuit boards 22 are respectively matched with the magnetic conductive columns 212 to form the windings, but the present disclosure is not limited thereto. For example, in other embodiments of the present disclosure not shown in the drawings, one coil circuit board 22 can form more than two printed circuits 221 to form more than two windings.

### Beneficial Effects of the Embodiment

In conclusion, in the motor structure and stator assembly thereof provided by the present disclosure, by virtue of “the printed circuits on the at least one coil circuit board being respectively wound around the magnetic conductive columns,” and “a material of the stator core being ferrite core or other magnetic material,” a switching speed of a motor control circuit is increased to achieve goals of low inductance, high power density and small size.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A motor structure, comprising:
a housing;
a stator assembly disposed in the housing; wherein the stator assembly includes:
a stator core having a magnetic core body and a plurality of magnetic conductive columns that are disposed on the magnetic core body, wherein a through hole is formed in a center of the magnetic core body, and the magnetic conductive columns are arranged around the through hole and are erected on the magnetic core body; and
at least one coil circuit board having a plurality of printed circuits corresponding to a quantity of the magnetic conductive columns, the printed circuits being respectively wound around the magnetic conductive columns; and
a rotor assembly disposed in the housing; wherein the rotor assembly is configured to rotate through the stator assembly.

2. The motor structure according to claim 1, wherein the magnetic conductive columns are evenly distributed around the through hole, and wherein, when a quantity of the at least one coil circuit board is one, a plurality of fixing through holes corresponding to the quantity of the magnetic conductive columns are formed in the coil circuit board, the fixing through holes are respectively provided for the magnetic conductive columns to pass through, and the printed circuits on the coil circuit board are respectively arranged around the fixing through holes.

3. The motor structure according to claim 2, wherein the coil circuit board is a multi-layer circuit board, the multi-layer circuit board includes a plurality of circuit boards; wherein each of the printed circuits includes a plurality of ring conductive patterns, the ring conductive patterns are spaced apart from each other, diameters of the ring conductive patterns on each layer of the circuit boards gradually increase in a direction away from the fixing through hole, and each of the ring conductive patterns of adjacent circuit boards is electrically coupled to each other through a via hole.

4. The motor structure according to claim 1, wherein the magnetic conductive columns are evenly distributed around the through hole, and wherein, when a quantity of the at least one coil circuit board corresponding to the quantity of the magnetic conductive columns is multiple, each of the coil circuit boards has a fixing through hole, the fixing through hole of the coil circuit boards is respectively sleeved around the magnetic conductive columns, each of the coil circuit boards has the printed circuit, and the printed circuit of each of the coil circuit boards is arranged around the fixing through hole.

5. The motor structure according to claim 4, wherein each of the coil circuit boards has a multilayer circuit board, the printed circuit of each of the coil circuit boards includes a plurality of ring conductive patterns on each layer of the circuit boards, and wherein the ring conductive patterns are spaced apart from each other, a diameter of the ring conductive patterns of each layer of the circuit boards gradually increases in a direction away from the fixed through hole, and each of the ring conductive patterns of adjacent circuit boards is electrically coupled to each other through a via hole.

6. The motor structure according to claim 1, wherein the rotor assembly includes a rotor bearing and a rotating shaft that is disposed on the rotor bearing, the rotating shaft is arranged on an axis of the rotor bearing.

7. The motor structure according to claim 1, further comprising a control circuit board, wherein a control circuit is disposed on the circuit board, the control circuit is electrically coupled to the stator assembly and the rotor assembly, and the control circuit is operable to control the stator assembly and the rotor assembly so that the rotor assembly is rotated in the through hole of the stator assembly.

8. The motor structure according to claim 1, wherein the motor structure further includes a control circuit that is integrated with the coil circuit board, the control circuit is electrically coupled to the stator assembly and the rotor assembly and is operable to control the stator assembly and the rotor assembly so that the rotor assembly is rotated in the through hole of the stator assembly.

9. The motor structure according to claim 1, wherein the magnetic core body and the magnetic conductive columns are configured to be integrally formed as a single one-piece structure; and wherein a material of the stator core is ferrite core.

10. A stator assembly of a motor structure, comprising:
a stator core having a magnetic core body and a plurality of magnetic conductive columns that are disposed on the magnetic core body, wherein a through hole is formed in a center of the magnetic core body, and the magnetic conductive columns are arranged around the through hole and are erected on the magnetic core body; and
at least one coil circuit board having a plurality of printed circuits corresponding to a quantity of the magnetic conductive columns, the printed circuits being respectively wound around the magnetic conductive columns.
